(19) United States
(12) Patent Application Publication
(10) Pub. No.: US 2013/0300997 A1
(43) Pub. Date: Nov. 14, 2013

(54) Apparatus for reducing laser speckle

(71) Applicants: Milan Momcilo Popovich, Leicester (GB); Jonathan David Waldern, Los Altos Hills, CA (US)

(72) Inventors: Milan Momcilo Popovich, Leicester (GB); Jonathan David Waldern, Los Altos Hills, CA (US)

(21) Appl. No.: 13/506,677

(22) Filed: May 9, 2012

(51) Int. Cl. G02F 1/1335; G02B 27/48; G02B 27/28; G02B 27/44

(52) U.S. Cl. 349/201; 359/489.08

(57) ABSTRACT

There is provided a device for reducing laser speckle comprising: a first transparent substrate; a second transparent substrate; an SBG sandwiched between said substrates; and transparent electrodes applied to said substrates. The first substrate is optically coupled to a laser source. The face of the second substrate in contact with the SBG is configured as an array of prismatic elements.

### CROSS REFERENCE TO RELATED APPLICATIONS

This application claims the priority of U.S. Provisional Patent Application No. 61/272,789 filed on 3 Nov. 2009 entitled DESPECKLER USING ANGULAR AND PHASE DIVERSITY.

This application incorporates by reference in its entirety PCT Application No. PCT/IB2008/001909 with international filing date 22 Jul. 2008.

### BACKGROUND OF THE INVENTION

The present invention relates to an illumination device, and more particularly to a laser illumination device based on electrically switchable Bragg gratings that reduces laser speckle.

Miniature solid-state lasers are currently being considered for a range of display applications. The competitive advantage of lasers in display applications results from increased lifetime, lower cost, higher brightness and improved colour gamut.

Laser displays suffer from speckle, a sparkly or granular structure seen in uniformly illuminated rough surfaces. Speckle arises from the high spatial and temporal coherence of lasers. Speckle reduces image sharpness and is distracting to the viewer.

Several approaches for reducing speckle contrast have been proposed based on spatial and temporal decorrelation of speckle patterns. More precisely, speckle reduction is based on averaging multiple sets of speckle patterns from a speckle surface resolution cell with the averaging taking place over the human eye integration time. Speckle may be characterized by the parameter speckle contrast which is defined as the ratio of the standard deviation of the speckle intensity to the mean speckle intensity. Temporally varying the phase pattern faster than the eye temporal resolution destroys the light spatial coherence, thereby reducing the speckle contrast.

Traditionally, the simplest way to reduce speckle has been to use a rotating diffuser that provides multiplicity of speckle patterns while maintaining a uniform a time-averaged intensity profile. This type of approach is often referred to as angle diversity. Another approach known as polarization diversity relies on averaging phase shifted speckle patters. In practice neither approach succeeds in eliminating speckle. A more effective approach would combine angle and polarization diversity.

It is known that speckle may be reduce by using an electro optic device to generate variations in the refractive index profile of material such that the phase fronts of light incident on the device are modulated in phase and or amplitude. The published Internal Patent Application No. WO/2007/015141 entitled LASER ILLUMINATOR discloses a despeckler based on a new type of electro optical device known as an electrically Switchable Bragg Grating (SBG). An (SBG) is formed by recording a volume phase grating, or hologram, in a polymer dispersed liquid crystal (PDLC) mixture. Typically, SBG devices are fabricated by first placing a thin film of a mixture of photopolymerizable monomers and liquid crystal material between parallel glass plates. Techniques for making and filling glass cells are well known in the liquid crystal display industry. One or both glass plates support electrodes, typically transparent indium tin oxide films, for applying an electric field across the PDLC layer. A volume phase grating is then recorded by illuminating the liquid material with two mutually coherent laser beams, which interfere to form the desired grating structure. During the recording process, the monomers polymerize and the HPDLC mixture undergoes a phase separation, creating regions densely populated by liquid crystal micro-droplets, interspersed with regions of clear polymer. The alternating liquid crystal-rich and liquid crystal-depleted regions form the fringe planes of the grating. The resulting volume phase grating can exhibit very high diffraction efficiency, which may be controlled by the magnitude of the electric field applied across the PDLC layer. When an electric field is applied to the hologram via transparent electrodes, the natural orientation of the LC droplets is changed causing the refractive index modulation of the fringes to reduce and the hologram diffraction efficiency to drop to very low levels. Note that the diffraction efficiency of the device can be adjusted, by means of the applied voltage, over a continuous range from near 100% efficiency with no voltage applied to essentially zero efficiency with a sufficiently high voltage applied. U.S. Pat. No. 5,942,157 and U.S. Pat. No. 5,751,452 describe monomer and liquid crystal material combinations suitable for fabricating SBG devices. Prior art SBG despecklers suffer from the problem of unacceptably high speckle contrast and high cost of implementation.

There is a requirement for an SBG despeckler with improved speckle contrast reduction.

### SUMMARY OF THE INVENTION

It is a first object of the present invention to provide an SBG despeckler with improved speckle contrast reduction.

In one embodiment of the invention there is provided a device for reducing laser speckle comprising: an SBG array device having an input surface and an output surface a second diffractive device having an input surface and an output surface a prismatic element of trapezoidal cross section having longer and shorter parallel rectangular facets and first and second tilted rectangular planar surfaces; and a polarization rotation mirror. The output surface of the SBG array device abuts a first tilted face of the prismatic element. The input surface of the second diffractive device abuts the first tilted face of said prismatic element. The polarization rotation mirror abuts the longer parallel surface of the prismatic element. The angles subtended at the longer surface by the tilted surfaces total ninety degrees. The input surface of the SBG array device admits collimated P-polarized light from a laser module. A first portion the input light is transmitted without deviation through the SBG array onto the polarization rotating mirror where it is reflected towards the second diffractive device and transmitted without deviation through the second diffractive device as S-polarized light into an output beam direction. A second portion the input light is diffracted by the SBG array device and is diffracted by the second diffractive device as P-polarized light into the output beam direction.

In one embodiment of the invention the second diffractive device is a non switchable non pixelated Bragg hologram.

In one embodiment of tie invention the second diffractive device is a switchable SBG array device.

In one embodiment of the invention the SBG array device comprises two identical stacked SBG arrays.

In one embodiment of the invention a device for reducing laser speckle comprising: an SBG array having an input surface and an output surface, a second diffractive device having an input surface and an output surface, a prismatic element of trapezoidal cross section having longer and shorter parallel rectangular facets and first and second tilted rectangular planar surfaces; and a polarization rotation mirror. The output surface of the SBG array and the input surface of the second diffractive device abut the longer parallel face of said prismatic element. The polarization rotation mirror abuts the shorter parallel surface of the prismatic element. The angles subtended at the longer surface by the tilted surfaces total ninety degrees. The input surface of the SBG array admits collimated P-polarized input light. A first portion of the input light is diffracted onto the polarization rotating mirror, reflected towards the second diffractive device and transmitted through the second device as S-polarized light into an output beam direction. A second portion of the input light is transmitted through the SBG arrays without deviation, undergoing total internal reflection at the inclined prism surfaces and being diffracted as P-polarized light into the output beam direction.

In one embodiment of the invention there is provided a device for reducing laser speckle comprising: red, green and blue laser sources; a rectangular optical medium; a SBG array device having an input surface and an output surface disposed adjacent a first longer surface of the optical medium. The apparatus further comprises red, green and blue reflecting mirrors and a broadband mirror disposed in series adjacent to the second longer surface of the optical medium. The input surface of the SBG array device provides separate input ports for admitting collimated light from then lasers sources along parallel red, green and blue input axes normal to the SBG input ports. The output surface of the SBG array device provides one output port for transmitting red, green and blue light along a common output direction. The red green and blue reflecting mirrors are located along and are each inclined at an angle of 45 degrees to the red, green and blue input axes while the broadband mirror is located along and inclined at an angle of minus 45 degrees to the output axis. The SBG array device diffracts P-polarized red, green and blue light into first second and third directions and transmits incident S-polarized red, green and blue light along the input axes. P-polarized red, green and blue light undergoes reflection at the second longer surface and then at an adjacent shorter surface of the optical medium before striking the output port at the first, second and third angles and being diffracted into the output direction. The S-polarized red, green and blue light is reflected by the red green and blue reflecting mirrors and the broadband mirror towards the SBG array device and is transmitted through the output port into the output direction.

In one embodiment of the invention the second longer surface is a TIR surface.

In one embodiment of the invention a PBS coating is applied to the portion of the longer surface illuminated by P-polarized light.

In one embodiment of the invention a retarder is disposed along the optical path between the blue reflecting mirror and the broad band mirror.

In one embodiment of the invention the optical medium is air.

In one embodiment of the invention a half wave plate is disposed along the optical path between the blue reflecting mirror and the broad band mirror.

In one embodiment of the invention there is provided a device for reducing laser speckle comprising: red, green and blue laser sources; a rectangular optical medium; a first SBG array device having an input surface and an output surface disposed adjacent a first surface of the optical medium; a second SBG array device having an input surface disposed adjacent an opposing surface of said optical medium and an output surface. The apparatus further comprises red, green and blue reflecting mirrors disposed in series adjacent a third face of said optical medium. The input surface of the first SBG array device admits red, green and blue light along a common input direction normal to the first SBG array device. The output surface of the second SBG array device transmits red green and blue light along a common output direction normal to the second SBG array device. The first SBG array device diffracts P-polarized red, green and blue light into first second and third directions and transmits incident S-polarized red, green and blue light without substantial deviation. P-polarized red, green and blue light undergoes reflection at the red, green and blue reflecting mirrors at said first, second and third angles. The second SBG array device diffracts the P-polarized red, green and blue light into the output to direction. The second SBG array device transmits the S-polarized red, green, and blue light into the output direction without substantial deviation.

In one embodiment of the invention illustrated in the schematic side elevation view of FIG. 15 there is provided an SBG despeckler device in which the SBG functions as an array of variable index prismatic elements. The SBG device comprises: a first transparent optical substrate with an input surface and an output surface; a second transparent optical substrate with an input surface and an output surface and an SBG sandwiched between the output surface of the first substrate and the input surface of the second substrate. Transparent electrodes (not illustrated) are applied to the output surface of the first substrate and the input surface of the second substrate. The electrodes are coupled to a voltage generator. The input surface of the first substrate is optically coupled to a laser source. The input surface of the second substrate is configured as an array of prismatic elements containing surfaces such as the ones indicated by 98A,98B. Advantageously, at least one of the input surface of the first substrate or the output surfaces of the second substrate is planar.

In one embodiment of the invention both of the transparent electrodes are continuous. The SBG is selectively switched in discrete steps from a fully diffracting to a non diffracting state by an electric field applied across the transparent electrodes.

In one embodiment of the invention at least one of the transparent electrodes is patterned to provide independently switchable electrode elements such that portions of the SBG may be selectively switched from a diffracting to a non diffracting state by an electric field applied across the transparent electrodes. Desirably, the electrodes are fabricated from ITO.

In one embodiment of the invention the electrode elements have substantially the same cross sectional area as a prismatic element.

In one embodiment of the invention the centre of said electrode element overlaps the vertex of a prismatic element.

In one embodiment of the invention the centre of an electrode element is offset from the vertex of a prismatic element.

In one embodiment of the invention the prism array is a linear array of elements of triangular cross section.

In one embodiment of the invention the prism array is a two-dimensional array comprising pyramidal elements.

In one embodiment of the invention the prismatic elements are identical.

In one embodiment of the invention the surface angles of the prismatic elements have a random distribution.

In one embodiment of the invention the prismatic elements are each characterised by one of at least two different surface geometries.

In one embodiment of the invention the prismatic elements are each characterised by one of at least two different surface geometries with the prismatic elements of a given surface geometry being distributed uniformly across the prism array.

In one embodiment of the invention the prismatic elements have diffusing surfaces.

In one embodiment of the invention the SBG is a subwavelength grating.

In one embodiment of the invention the laser source comprises red green and blue emitters.

In one embodiment of the invention the SBG despeckler device further comprises a beam shaping diffuser.

In one embodiment of the invention the SBG despeckler device further comprises a beam collimating lens.

In one embodiment of the invention the SBG despeckler device further comprises a beam shaping diffuser and at least one beam collimating lens.

A more complete understanding of the invention can be obtained by considering the following detailed description in conjunction with the accompanying drawings wherein like index numerals indicate like parts. For purposes of clarity details relating to technical material that is known in the technical fields related to the invention have not been described in detail.

### BRIEF DESCRIPTION OF THE DRAWINGS

FIG. 1 is a schematic side elevation view of one embodiment of the invention.

FIG. 2 is a schematic side elevation view of one embodiment of the invention.

FIG. 3 is a table summarizing the operational states of one particular embodiment of the invention.

FIG. 4A is a schematic side elevation view of one particular embodiment of the invention.

FIG. 4B is a schematic side elevation view of one particular embodiment of the invention.

FIG. 4B is a schematic view of an aspect of one particular embodiment of the invention.

FIG. 5 is a schematic side elevation view of one embodiment of the invention.

FIG. 6 is a schematic plane view of a detail of one embodiment of the invention.

FIG. 7 is a schematic side elevation view of one embodiment of the invention.

FIG. 8 is a schematic side elevation view of one embodiment of the invention.

FIG. 9 is a schematic side elevation view of one embodiment of the invention.

FIG. 10 is a schematic side elevation view of one embodiment of the invention.

FIG. 11 is a schematic side elevation view of one embodiment of the invention.

FIG. 12 is a schematic side elevation view of apparatus for use in one embodiment of the invention.

FIG. 13 is a schematic side elevation view of apparatus for use in one embodiment of the invention.

FIG. 14 is a schematic side elevation view of one embodiment of the invention using a mechanical transducer.

FIG. 15 is a schematic side elevation view of one embodiment of the invention using an array of prismatic elements.

FIG. 16 is a schematic side elevation view of one aspect of one embodiment of the invention using an array of prismatic elements.

FIG. 17A is a schematic side elevation view of a first aspect of one embodiment of the invention using an array of prismatic elements.

FIG. 17B is a schematic side elevation view of a second aspect of one embodiment of the invention.

FIG. 17C is a schematic side elevation view of a third aspect of one embodiment of the invention using an array of prismatic elements.

FIG. 18 is a schematic view of one embodiment of the invention using an array of prismatic elements.

### DETAILED DESCRIPTION OF THE INVENTION

It an object of the present invention to provide an SBG despeckler with improved speckle contrast reduction.

It will be apparent to those skilled in the art that the present invention may be practiced with only some or all aspects of the present invention as disclosed in the following description. For the purposes of explaining the invention well-known features of laser technology and laser displays have been omitted or simplified in order not to obscure the basic principles of the invention.

Parts of the following description will be presented using terminology commonly employed by those skilled in the art of optics and laser displays in particular.

In the following description the terms light, ray, beam and direction will used interchangeably and in association with each other to indicate the propagation of light energy along rectilinear trajectories.

Unless otherwise stated the term optical axis in relation to a ray or beam direction refers to propagation parallel to an axis normal to the surfaces of the optical components described in relation to the embodiments of the invention.

It should also be noted that in the following description of the invention repeated usage of the phrase “in one embodiment” does not necessarily refer to the same embodiment.

An SBG despeckler device according to the principles of the invention typically comprises at least one SBG element. Each SBG layer has a diffracting state and a non-diffracting state. Typically, the SBG element is configured with its cell walls perpendicular to an optical axis. An SBG element diffracts incident off-axis light in a direction substantially parallel to the optical axis when in said active state. However, each SBG element is substantially transparent to said light when in said inactive state. An SBG element can be designed to diffract at least one wavelength of red, green or blue light. In the embodiments to be discussed in the following description of the invention at least one SBG layer in the SBG despeckler device is configured as an array of selectively switchable SBG pixels.

SBG despeckler devices for reducing speckle according to the principles of the present invention are configured to generate set of unique speckle patterns within an eye resolution cell by operating on the angular and phase characteristic of rays propagating through the SBG despeckler device.

The SBG despeckler devices disclosed herein may be used to overcome both objective and subjective speckle.

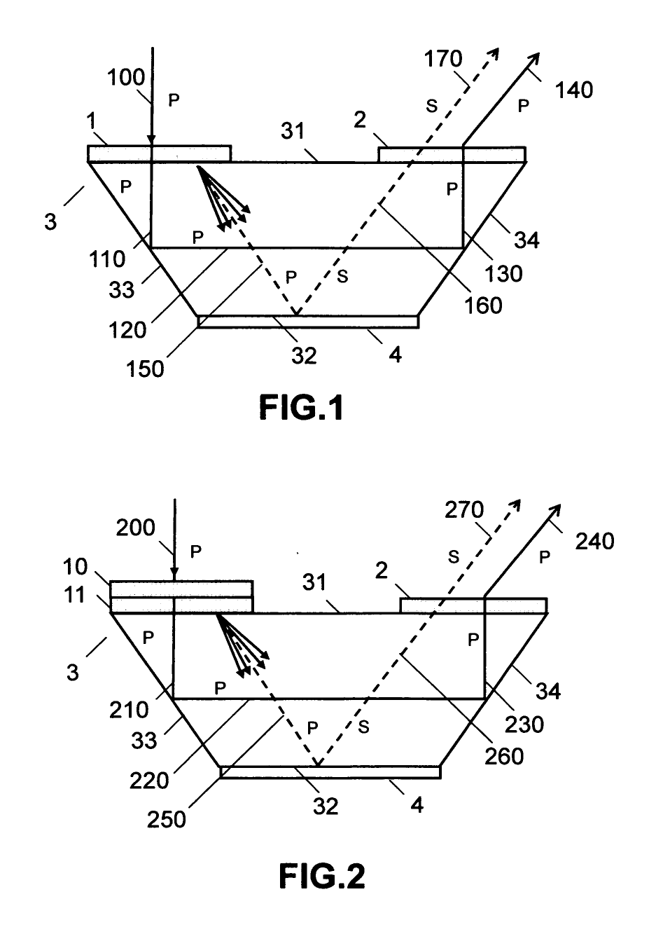

In one embodiment of the invention illustrated in the schematic side elevation view of FIG. 1 the despeckler device comprising an SBG array device, a second diffractive device and a trapezoidal prism. The SBG array device and the second diffractive device each have an input surface and an output surface. The trapezoidal prism comprises parallel surfaces 31,32 and the inclined surfaces 33,34. The output surface of the SBG array device and the input surface of the second diffractive device abut the surface 31. A polarization rotation mirror abuts the surface 32. The surfaces 33 are inclined to surface 31 at angles that sum to ninety degrees. The input surface of the SBG array is optically coupled to a laser module providing P-polarized output light 100. The output surface of the second diffractive device is optically coupled to a means for combining red green and blue illumination which is directed towards a flat panel display. The polarization rotation mirror may be a multilayer coating applied to the surface 32. Alternatively the polarization rotation mirror may be a separate component abutting the surface 32.

The SBG array device comprises an array of SBG elements each encoding a diffuser. The despeckler relies on combining the effects of many different types of diffuser patterns encoded within the SBG array. The diffuser patterns may rely on angular diffusion patterns for providing angular diversity with an effect similar to that of a rotating ground glass diffuser. In preferred embodiments of the invention a multiplicity of different diffuser pattern are recorded in a master diffi ctive element such as a CGH. Said multiplicity of different diffuser patterns are then recorded into the SBG arrays. The individual diffuser prescriptions may be designed to provide diffusion patterns characterised by scattering angles, scattering pattern asymmetries, structure diffusion patterns and many others. The invention is not restricted to any particular type of diffusion pattern. Typically the diffusion has an angular extent of ±7.5 degrees. However, much smaller or larger diffusion angles may be provided depending on the application.

We next consider the propagation of light through the despeckler device. Turning again to FIG. 1 we see that a first portion of the incident P-polarized light 100 is transmitted through the first SBG array with significant deviation or attenuation as first order or non diffracted light 110. The ratio of first order to diffracted light at any time will depend on the voltage applied across the SBG array. The zero order light 110 is reflected at the surface 33 into the direction 120 and is reflected a second time by the surface 34 into direction 130. The P-polarized light 130 strikes the input surface of the second diffractive device and is diffracted into an output direction 140 as P-polarized light. A second portion of the P-polarized light incident 100 on the input surface of the SBG array is diffracted as a diffuse beam in the directions generally indicated by 150 towards the polarization rotating mirror. The polarization rotating mirror simultaneously converts the diffracted P-polarized light 150 to S polarized light and reflects said light in the direction 160 towards the second diffractive device. The S polarized light 160 strikes the input surface of the second diffractive device and is transmitted without significant loss into the output direction 170 as S-polarized light.

In the embodiment of FIG. 1 the second diffractive device is not switchable and diffracts P-polarized light at all times. It should be noted that non switchable Bragg gratings formed in HPDLC offer benefits in terms of the greater control of refractive index modulation afforded by HPDLC. In such embodiments the SBGs would not require electrodes.

In one embodiment of the invention the SBG elements may have identical diffusion prescriptions. Such an array can be provided by providing uniform diffusion characteristics across the entire HPDLC layer and relying on the electrodes to provide the pixilation of the diffuser. In one embodiment of the invention the number of possible speckle patterns can be greatly increased by recording a master array of CGH elements with unique pre-computed diffuser prescriptions mapped to the individual pixels in the SBG arrays. The SBG array will typically have a resolution of at least 10×10. Much higher resolutions are possible depending on the constraints of size, cost, electronic drive complexity and other factors.

The SBG array is switched using an active matrix switching scheme. The preferred matrix addressing schemes are the ones described in the co-pending PCT application PCT Application No. PCT/IB2008/001909

Advantageously, the surfaces 33,34 function as total internal reflection (TIR) surfaces. In one embodiment of the invention mirror coatings may be applied to the surfaces 33,34. In one embodiment of the invention the surfaces 33,34 are each inclined at 45 degrees to the surface 31.

In one embodiment of the invention the optical medium of the trapezoidal prism may be air with the surfaces 31,32,33,34 being air separated mirrors.

In one embodiment of the invention the second diffractive is a plane grating without pixilation in other words a grating in which the Bragg surface vectors are aligned in a common direction such that a collimated input beam in a first direction is deflected into a collimated beam in a second direction.

In one embodiment of the invention the second diffractive device shown in FIG. 1 may be an SBG array

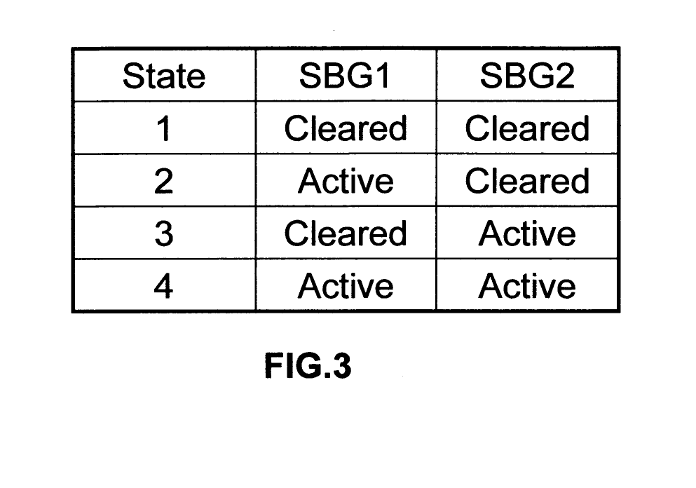

In one embodiment of the invention illustrated in the schematic side elevation view of FIG. 2 the first SBG array is replaced by stack of two identical SBG arrays 10,11. The use of two SBG arrays allows four different states for reducing speckle as summarized in the tab le of FIG. 3.

a) In a first state both SBG arrays are inactive;

b) In a second state the SBG array 10 is active and the SBG array 111 is inactive;

c) In a third state the SBG array 10 is inactive and the SBG array 111 is active;

d) In a fourth state both SBG arrays are active.

In one embodiment of the invention the SBG arrays 10 and 11 are operated in anti phase. In other words there is a phase lag between the voltages applied across the SBG arrays. The effect of applying such waveforms is that the average intensity of the speckle phase cells remains substantially constant, thereby satisfying the statistical requirements for speckle reduction. Other types of waveforms may be applied, for example sinusoidal, triangular, rectangular or other types of regular waveforms. Alternatively, it may be advantageous in statistical terms to use waveforms based on a random stochastic process. It should be noted that since the SBG arrays are driven in anti-phase only one SBG element is active at any time along a give ray path through the SBG arrays.

In one embodiment of the invention the SBG arrays are offset by a fraction of the SBG element width in at least one of the vertical or horizontal array axes. In some cases the SBGs may be offset by an SBG element width in at least one of the vertical or horizontal axes.

Referring to FIG. 2 we see that a first portion of the incident P-polarized light 100 is transmitted through the first SBG array with significant deviation or attenuation as first order or non diffracted light 210. The zero order light 210 is reflected at the surface 33 into the direction 120 and is reflected a second time by the surface 230 into direction 230. The P-polarized light 230 strikes the input surface of the second diffractive device and is diffracted into an output direction 240 as P-polarized light. A second portion of the P-polarized light incident 100 on the input surface of the SBG array is diffracted in the direction 250 towards the polarization rotating mirror. The polarization rotating mirror simultaneously converts the diffracted P-polarized light 250 to S polarized light and reflects said light in the direction 260 towards the second diffractive device. The S polarized light 260 strikes the input surface of the second diffractive device and is transmitted without significant loss into the output direction 270 as S-polarized light.

In the embodiment of FIG. 2 the second diffractive device is not switchable and diffracts P-polarized light at all times.

In one embodiment of the invention the second diffractive device shown in FIG. 1 may be an SBG array. It will be clear from consideration of FIGS. 1-2 an embodiment in which the second diffractive device is an SBG array can be used to provide equivalent states to the ones listed above in relation to the embodiment of FIG. 2.

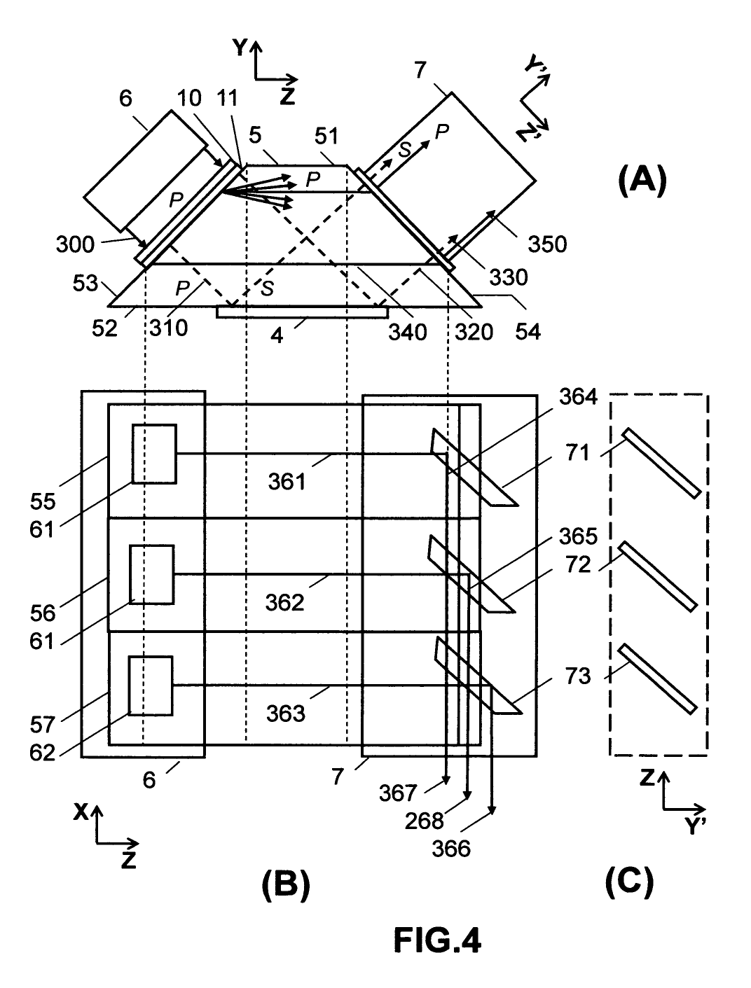

In one embodiment of the invention illustrated in FIG. 4 there is provided a despeckler device comprising stacked first and second SBG 1rrays 10,11, a second diffractive device 2 and a trapezoidal prism 5. The apparatus is illustrated in schematic side elevation and plan view in FIGS. 4A and 4B. The orthogonal XYZ coordinates are indicated in the drawing. The SBG array stack and the second diffractive device each have an input surface and an output surface. The trapezoidal prism comprises surface parallel surfaces 51,52 and the inclined surfaces 53,54. The output surface of the SBG array stack abuts surface 53 and the input surface of the second diffractive device abuts the surface 54. A polarization rotation mirror 4 abuts the surface 3. The surfaces 53,54 are inclined to surface 51 at angles that sum to ninety degrees. The input surface of the SBG array is optically coupled to a laser module 6 providing collimated P-polarized output light 300. The output surface of the second diffractive device is optically coupled to a means 7 for combining red green and blue illumination which is directed towards a flat panel display which is not illustrated.

A first portion of the incident P-polarized light 300 is transmitted through the first SBG array with significant deviation or attenuation as first order or non diffracted light 310. The ratio of first order to diffracted light at any time will depend on the voltage applied across the SBG array. The polarization rotating mirror simultaneously converts the diffracted P-polarized light 310 to S polarized light and reflects said light in the direction 320 towards the second diffractive device whereupon it is transmitted without significant loss into the output direction 330 as S-polarized light. A second portion of the P-polarized light incident 100 on the input surface of the SBG array is diffracted in the direction 340 towards the input surface of the second diffractive device whereupon it is diffracted into an output direction 350 as P-polarized light.

As indicated in the plan view of FIG. 4B red green and blue channels are provided by abutting identical trapezoidal prisms 55,56,57 and providing red, green and blue laser sources indicated by 61,62,63. The means 7 for combining red green and blue illumination comprises a mirror 71 a green reflection dichroic filter and a blue reflecting dichroic filter. The mirror and filters may be separated by glass or optical plastic. In one embodiment of the invention mirror and filters may be air spaced. The red, green and blue light transmitted from the input surface of the SBG array stack to the output surface of the second diffractive device is indicated in plan view by 361,362,363 respectively. The red light 361 is reflected by the mirror 71 in the direction 364 and transmitted by the dichroic filters 72,73 to provide collimated output light 367. The green light 361 is reflected in the direction 365 by the dichroic filter 72 and transmitted by the dichroic filters 73 to provide collimated output light 367. The blue light 363 is reflected by the dichroic filter 73 to provide collimated output light 366.

FIG. 4C indicates the disposition of the mirror 71 and prisms 72,73 in the rotated coordination frame X′Y′Z where the direction Y′ is parallel the optical axis of the second diffractive device.

In the embodiment of FIG. 4 the second diffractive device is not switchable and diffracts P-polarized light at all times. It should be noted that non switchable Bragg gratings formed in HPDLC offer benefits in terms of the greater control of refractive index modulation afforded by HPDLC. In such embodiments the SBGs would not require electrodes.

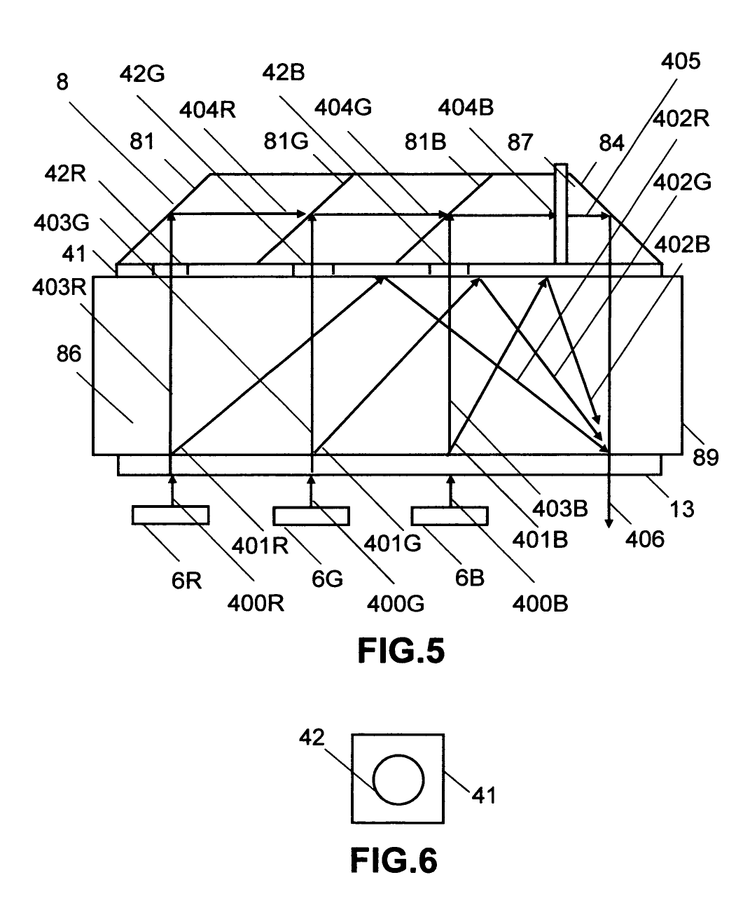

In one embodiment of the invention illustrated in FIGS. 5-6 there is provided a compact illumination device incorporating a despeckler based angular and phase diversity. Referring to FIG. 5 we see that the apparatus comprises red, green and blue lasers 6R, 6G,6B; an SBG array device 13; a transparent substrate having a first face in optical contact with the output surface of the SBG array device and a second face to which a mirror coating 41 has been applied; and a trapezoidal prismatic beam combining module having a longer parallel face abutting the mirrored face of the substrate 86; and first and second tilted faces 81,85. The mirror coating contains transparent circular optical ports 42,43,44,45. The beam combining module which is divided into four abutting elements comprises in series a first tilted mirror 81 applied to said first tilted surface, a tilted green light reflecting dichroic filter 81G, a tilted blue reflecting dichroic filter 81B; a polarization control device 84 and a second mirror coating applied to said second tilted surface 85. The first mirror coating, green dichroic filter, blue dichroic filter, HWP and second mirror coating are separated by an optical medium. The optical medium is desirably glass or optical plastic. The optical medium may be air. In one embodiment of the invention the above described beam combiner components may be configured as air-space elements. FIG. 6 is a plan view of a portion of the mirror coating 41 showing the optical port 42. Typically, such a port would be provided by applying an opaque circular mask to the substrate during the mirror deposition process. Typically the mirrors 81,82R,82G are tilted at 45 degrees and the mirror 84 is tilted at −45 degrees.

We first consider the propagation of red illumination light through the apparatus of FIG. 5. The laser module 6R provides P-polarized collimated output light 400R. The SBG array device diffracts a first portion of the light 400R into the direction 401R. The light 401R strikes the mirror 41 and is reflected back as the light 402R towards the SBG array device. In a similar fashion portions of light from the laser modules 6G,6B propagate along the ray paths 400G,401G,402G and 400B,401B,402B. The beams 402R,402G,402B substantially overlap at SBG array device. From consideration of the basic geometry of FIG. 5 it will be appreciated that the separations of the input red, green and blue lasers beams at the SBG array required to achieve coincidence of the output beams are determined by diffraction angles and the thickness of the substrate. The diffraction angles of beams 401R,401G,401B are determined by the Bragg equation 2.d.sin U=L where d is the Bragg grating fringe spacing, L is the wavelength and U is the Bragg diffraction angle. The SBG properties are uniform across the SBG array device. Since the angles of incidence of rays 402R,402G,402B at the SBG are identical to the diffraction angles of the rays 401R,401G,401B it will be clear from the symmetry of diffraction gratings that the rays are diffracted into a common output direction 406 as P-polarized light.

We next consider the propagation of light from the lasers that is not diffracted by the SBG array device. The SBG array device transmits second portions of the input light without substantial deviation or attenuation into the beam directions 403R,403G,403B, said light being transmitted through the optical ports 42,43,44 respectively.

The red beam 403R is reflected by the mirror 81 into the direction 404R. The green beam 403G is reflected by the dichroic mirror 81G into the direction 404G. The blue beam 403B is reflected by the dichroic mirror 81B into the direction 404B. The red, green and blue beams are transmitted through the HWP 84 to provide sequential red, green and blue S-polarized light 405. The light 405 is reflected by the mirror 85 into the direction 407 towards the SBG array device. The intersection of the light 407 with the SBG array devices coincides with the areas of intersection of the beams 402R,402G,402B. However, the red, green, blue light 407 is transmitted through the SBG array device without substantial attenuation or deviation in the direction 406.

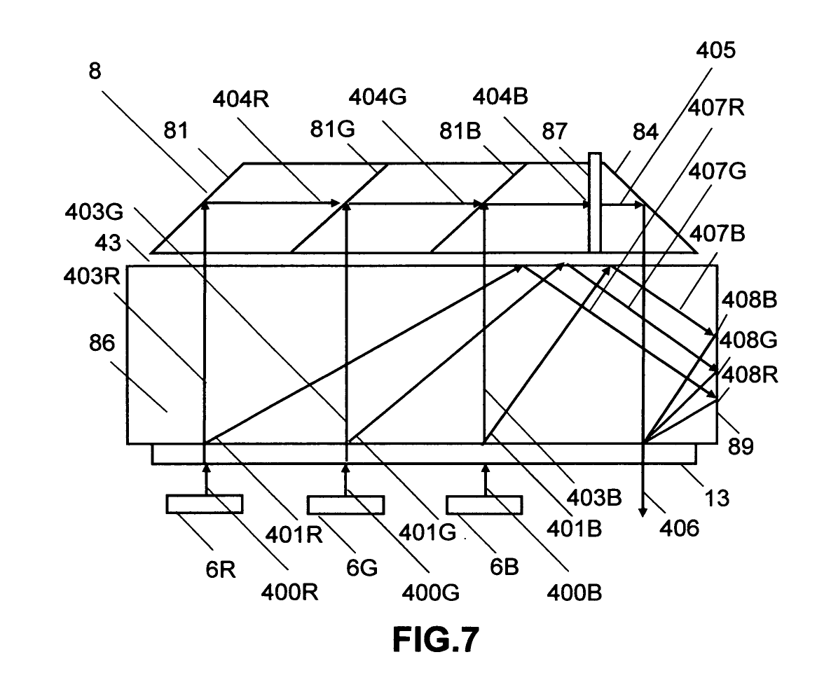

In one embodiment of the invention illustrated in the schematic side elevation view of FIG. 7 there is provided a compact illumination device similar to the embodiment of FIG. 6. In the embodiment of FIG. 7 the mirror coating 41 and ports 42R,42G,42B provided therein is replace by the air space indicated by 43. The beam paths 401R,401G,401B in the optical medium 86 now undergo total internal reflection to provide reflected beams 407R,407G,407B which are in turn reflected by the surface 89 to provide the beams 408R,408G,408B. Since the angles of incidence of rays 408R,408G,408B at the SBG array device are identical to the diffraction angles of the rays 401R,401G,401B it will be clear from the symmetry of diffraction gratings that the rays are diffracted into a common output direction 406 as P-polarized light. The S-polarized output light is provided in an identical fashion to that of the embodiment of FIG. 6.

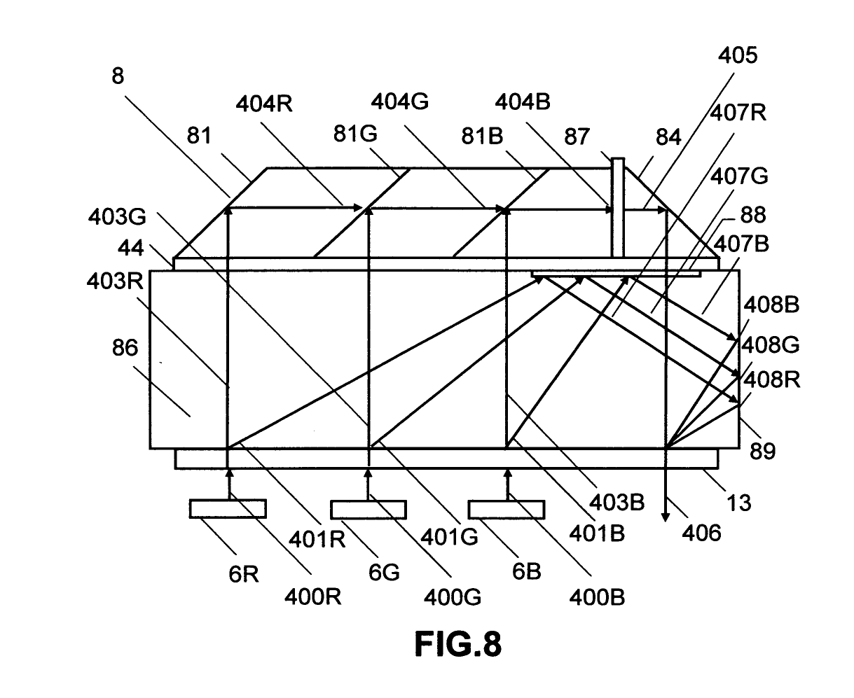

In one embodiment of the invention illustrated in the schematic side elevation view of FIG. 8 there is provided a compact illumination device similar to the embodiment of FIG. 6. In the embodiment of FIG. 8 the mirror coating 41 and ports 42R,42G,42B provided therein is replace by the optical substrate 44. A polarizing beam splitter (PBS) coating 84 is applied to portion of the substrate. The beam paths 401R,401G,401B in the optical medium 86 are reflected by the PBS to provide reflected beams 407R,407G,407B which are in turn reflected by the surface 89 to provide the beams 408R,408G,408B. The beam angles and the dimensions of the medium 86 are optimised to ensure that the P-polarize light 401R,401G,401B strikes the PBS coated portion of the substrate while the S-polarized light 403R,403G,403B strikes the uncoated portion of the substrate. Since the angles of incidence of rays 408R,408G,408B at the SBG array device are identical to the diffraction angles of the rays 401R,401G,401B it will be clear from the symmetry of diffraction gratings that the rays are diffracted into a common output direction 406 as P-polarized light. The S-polarized output light is provided in an identical fashion to that of the embodiment of FIG. 6 except that in the embodiment of FIG. 8 said S-polarized light traverses the PBS coated portion of the substrate 44. In one embodiment of the invention the optical medium 86 is air. In an exemplary embodiment of the invention based on the embodiment of FIG. 8 in which the optical medium 86 is air there are provided red green and blue laser sources having wavelengths 640 nm, 532 nm and 445 nm. and the SBG array device is configured to provide diffracted beams 401R,401G,401B having input angles in the optical medium of 52°, 40°,33° respectively.

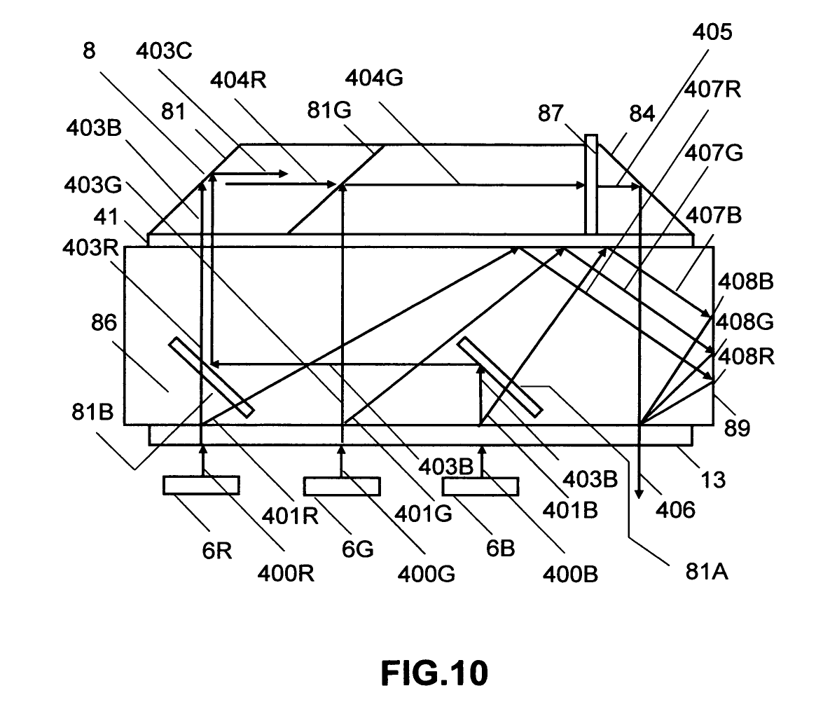

In certain applications there it is difficult to avoid the S-polarized blue light beam 403B intercepting the PBS 84. This problem can be overcome by the embodiment of the invention shown in FIG. 10 in which the blue reflecting mirror 81B is replaced by the two PBS elements 81A,81B. The blue S-polarized blue light beam 403B is reflected by the PBS element 81A to provide the beam 403A and is then reflected by the PBS element 81B to provide the beam 403B. The beam 403B is reflected by the mirror 81 into the direction 403C and is combined with the red and green beams 403R, 403G.

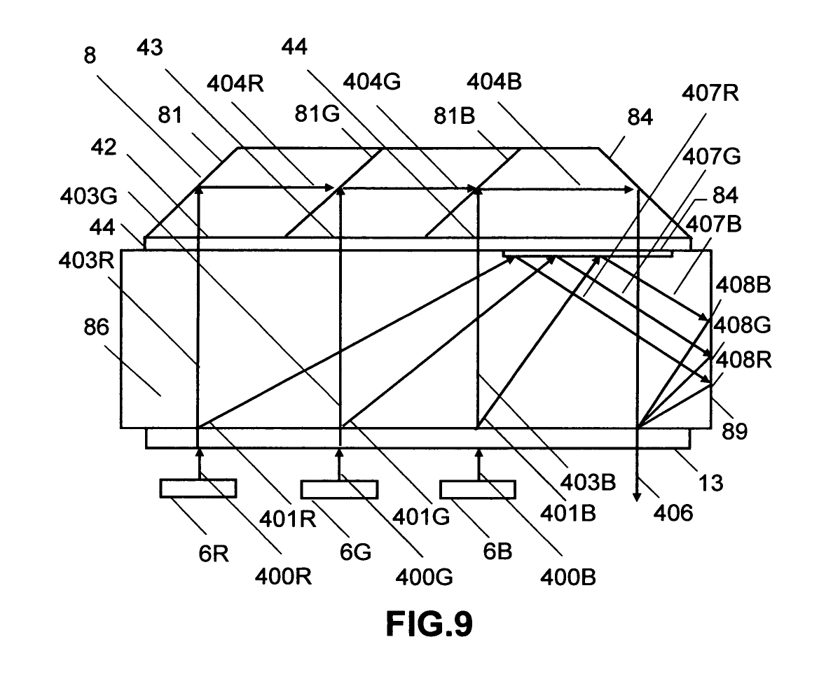

In any of the embodiments illustrated in FIGS. 5-10 the polarization control device 87 may be a half wave plate (HWP). Alternately, the polarization control device may be a retarder providing any predetermined amount of retardation. In one embodiment of the invention illustrated in the schematic side elevation view of FIG. 9 the polarization control device 87 is eliminated. Since the beams 403R,403G,403B maintain their S-polarized state along their entire propagation path eliminating the need for the polarization control device.

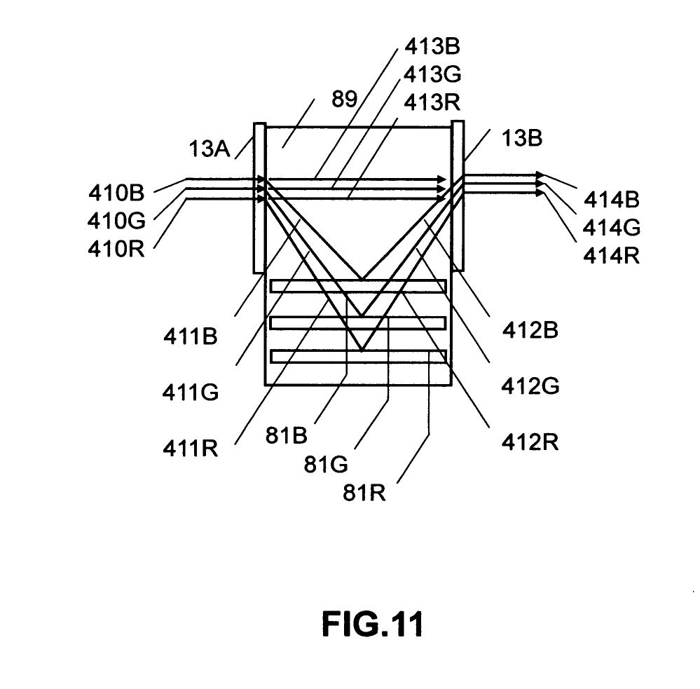

In one embodiment of the invention illustrated in the schematic side elevation view of FIG. 11 there are provided identical first and second SBG array devices 13A,13B disposed in opposing senses and sandwiching an optical medium 89. Red, green and blue reflecting mirrors 81R,81G,81B disposed in a stack adjacent to said optical medium. The mirrors may be multilayer coatings applied to substrates. The mirrors may be separated by transparent spacers. The optical medium, mirror substrates and spacers may be fabricated from a common material such as glass or plastic. The optical medium may be air. The mirror substrates may be separated by air gaps. The first SBG array device 13A diffracts normally incident collimated red, green, blue collimated P-polarized light indicated by 410R,410G,410B into the beam directions 411R,411G,411 respectively. The beams 411R,411G,411B are reflected by the red, green, blue mirrors 81R,81G,81B into the directions 412R,412G,412B respectively. Incident S-polarized light is not diffracted and propagates without substantially deviation or transmission loss as S-polarized light 413R,413G,413B. Finally, the P-polarized beams 412R,412G,412B are diffracted by the second SBG array device into parallel collimated output beams. The beams 413R,413G,413B are transmitted through the SDBGH without substantial deviation or loss and combined with the P-polarized beams to provided the red, green, blue collimated output light 414R,414G,414B.

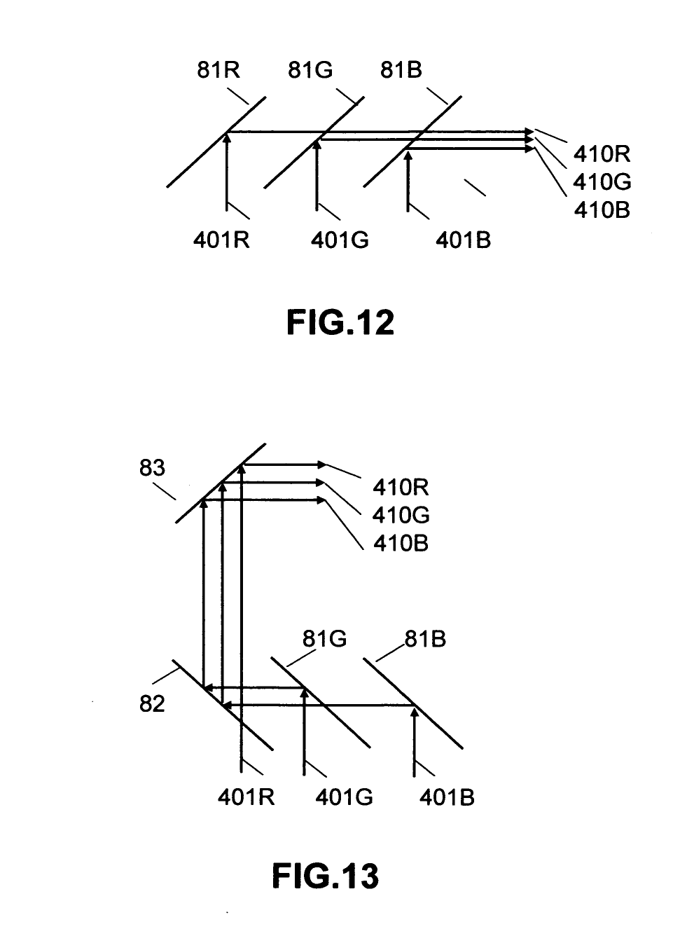

It will be clear from consideration of FIG. 12 that many methods for introducing red, green and blue 410R,410G,410B light along a substantially common path as indicated will be known to those skilled in the art of optical design. For example light, turning to FIG. 11 it will be appreciated that parallel collimated red, green and blue beams 401R,401G,401B may be combined into a common path using the red green blue reflected mirrors 81R,81G,81B disposed in an optical medium.

Alternatively, using the optical apparatus illustrated in FIG. 13 light from parallel collimated red, green and blue beams 401R,401G,401B may be combined into a common path using green and blue reflecting mirror 81G,81B and a dichroic filter 82 operative to transmit red light while transmitting blue and green light and a broad band mirror 83.

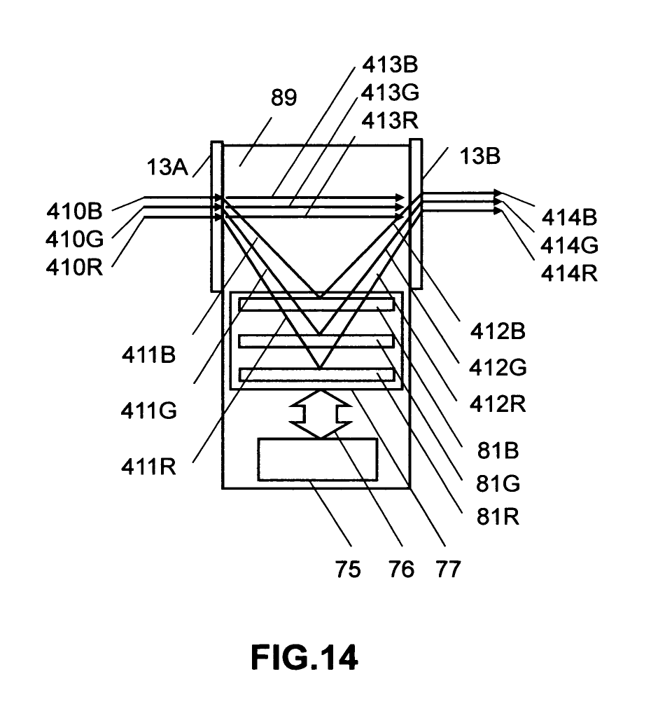

The performance of the SBG despeckler device illustrated in FIG. 11 may be enhanced by incorporating a mechanical transducer. Referring to FIG. 14 it will be seen that such an embodiment of the invention comprises the apparatus of FIG. 11 in which the dichroic reflectors are now contained in a linearly translatable assembly indicated by 77. The assembly 77 is vibrated along the direction normal to the surfaces of the mirrors by a mechanical transducer indicated by 75 that applies a vibratory force indicated by 76. In one embodiment of the invention the mechanical transducer is a piezoelectric device. In one embodiment of the invention the mechanical transducer provides a random vibration of the assembly 77 characterized by at least one of a random phase or a random amplitude.

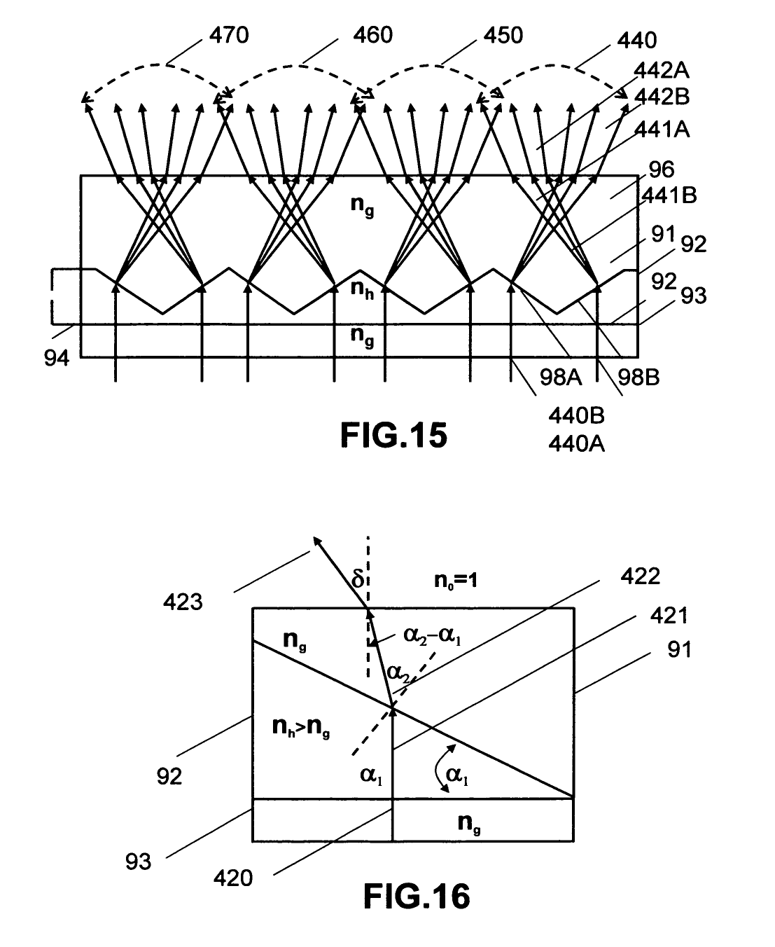

In one embodiment of the invention illustrated in the schematic side elevation view of FIG. 15 there is provided an SBG despeckler device in which the SBG functions as an array of variable refractive index prismatic elements. The SBG device of FIG. 15 comprises: a first transparent optical substrate 93 with an input surface and an output surface 94; a second transparent optical substrate 91 with an input surface 95 and an output surface, and an SBG 92 sandwiched between the output surface of the first substrate and the output surface of the second substrate. Transparent electrodes are applied to the output surface of said first substrate and the input surface of said second substrate. The electrodes are coupled to a voltage generator 99. The input surface of the first substrate is optically coupled to a laser source. The output surface of the first substrate is configured as an array of prismatic elements each prismatic element containing surfaces such as 98A,98B. Advantageously, at least one of the input surface of the first substrate or the output surfaces of the second substrate is planar. The substrates are fabricated from an optical glass such as BK7. Alternatively, optical plastics may be used.

In one embodiment of the invention the SBG is a subwavelength grating recorded in HPDLC. A subwavelength grating is fabricated in a similar way to a SBG. The principles of subwavelength gratings recorded in HPDC material system are disclosed in U.S. Pat. No. 5,942,157 by Sutherland et al, entitled SWITCHABLE VOLUME HOLOGRAM MATERIALS AND DEVICES, issued 24 Aug. 1999. The property of a subwavelength grating that is exploted in the present invention is its ability to function as a variable refractive index medium. It should be noted that it does not behave like a conventional Bragg grating. However, for the purposes of explaining the invention we include subwavelength gratings recorded in HPDLC in the SBG category. Typically, such a grating offers the benefits of high modulation speed but no laser beam optical interaction (grating coupling).

We consider the propagation of light through one of the prismatic elements. Input laser light indicated by the rays 440A,440B is transmitted through substrate 94 into the HPDLC Refracted rays from a first prism surface are indicated by 441A and refracted rays from a second prism surface are indicated by 441B. Each of the refracted rays in the groups indicated by 441A,441B corresponds to a unique average refractive index resulting from a unique applied voltage. The rays 441A,441B are refracted at the output surface of the second substrate 96 to provide the output rays 442A,442B. As indicated in the drawing each prism will provide overlapping rays indicated by the divergent ray bundles 440,450,460,470.

The ray geometry is illustrated in more detail in FIG. 16 which provides a schematic illustration of the ray propagation around one prism face. The angle of deflection in the prism is given by α₂=arcsin ((nₕ/n_{g}) sin (α₁), which is approximately equal to (nₕ/n_{g}) α₁. The prism angle α₁ is given by α₁=arctan (h/D), where D is the length of the prism (or period) and h is its height. It can be shown that the resulting angle of prism deflection δ is given by δ=arcsin (n_{g} sin(α₂−α₁). Making the approximation that δ=n_{g} (α₂−α₁), we obtain: δ=n_{g} α₂ (nₕ/n_{g}−1). Combining both previous equations, the deflection angle may be expressed as a function of the prism characteristics and index. Based on the above equations the ray deflection is given by δ=n_{g} ((h/D) (nₕ/n_{g}−1). The directions of the output rays are swept by increasing the effective refractive index in the HPDLC between the substrate-HPDLC index match condition and the full effective index shift. Typically, the index of glass is n_{g}=1.55. The index of the HPDLC nₕ in its non diffracting state is matched to the index of the substrate glass which is typically 1.55. The inventors have found that the maximum refractive variation of the HPDLC is typically +0.065. The HPDLC material has a sinusoidal sub-wavelength grating with a peak amplitude of 50% of the index swing regions (bright fringes). Therefore the maximum effective refractive index change extends from 1.55 to 1.55+0.065/2=1.5825. Assuming a prism height of 1 micron, a prism length of 30 microns, and n_{g}=1.55 and nₕ=1.5825, we obtain a deflection angle of 0.062 degrees.

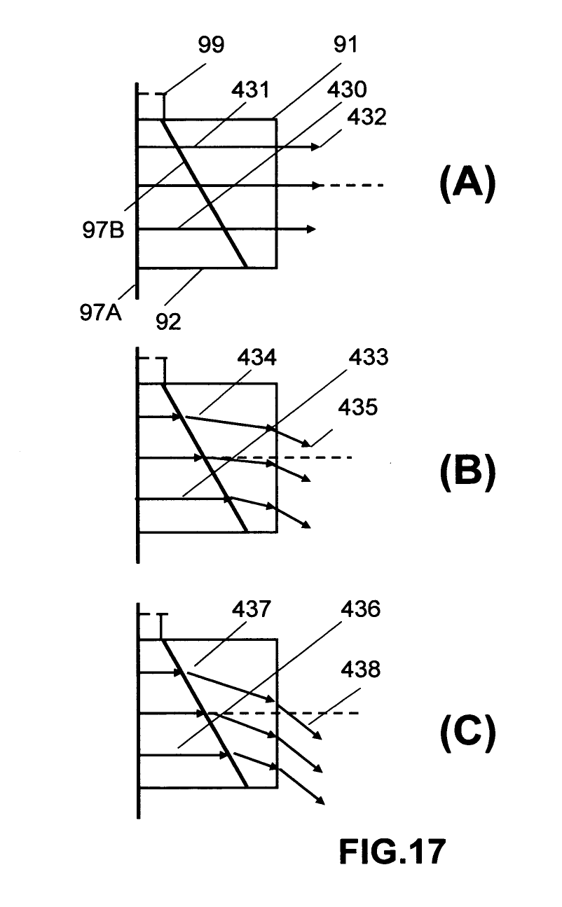

FIG. 17 illustrates the sweeping of output rays as the voltage applied across the SBG via the electrodes 97A,97B is varied. At the maximum voltage condition illustrated in FIG. 17A there is nor deflection in the incoming rays 430 which propagate into the HPDLC region 91 as the rays 431 and subsequently into air as rays 432 without deviation. FIGS. 17B-17C show how the ray deviation increases as the voltage is reduced. In FIG. 17B input collimated light 433 is deflected into the ray directions 434 in the HPDLC medium and into ray direction 435 in air. In FIG. 17C input collimated light 436 is deflected into the ray directions 437 in the HPDLC medium and into ray direction 438 in air.

In one embodiment of the invention both of the transparent electrodes are continuous. The grating is selectively switched in discrete steps from a fully diffracting to a non diffracting state by an electric field applied across the transparent electrodes.

At least one of said transparent electrodes is patterned to provide independently switchable electrode elements such that portions of the grating may be selectively switched in discrete steps from a fully diffracting to a non diffracting state by an electric field applied across the transparent electrodes. Desirably, the electrodes are fabricated from ITO.

In one embodiment of the invention the electrode elements have substantially the same cross sectional area as a prismatic element.

In one embodiment of the invention the centre of said electrode element overlaps the vertex of a prismatic element.

In one embodiment of the invention the centre of an electrode element is offset from the vertex of a prismatic element.

In one embodiment of the invention wherein the prism array is a linear array of elements of triangular cross section as illustrated in FIG. 15

In one embodiment of the invention the prism array is a two-dimensional array comprising pyramidal elements of cross section similar to the one illustrated in FIG. 15. In such an embodiment ray deflections occur in two directions.

In one embodiment of the invention the prismatic elements are identical. Such an embodiment of the invention is also illustrated by FIG. 15.

In one embodiment of the invention the surface angles of the prismatic elements have a random distribution. Such an embodiment of the invention is also illustrated by FIG. 15.

In one embodiment of the invention the prismatic elements are each characterised by one of at least two different surface geometries. Such an embodiment of the invention is also illustrated by FIG. 15.

In one embodiment of the invention the prismatic elements are each characterised by one of at least two different surface geometries with the prismatic elements of each surface geometry being distributed uniformly across the prism array.

In one embodiment of the invention the prismatic elements have diffusing surfaces.

In one embodiment of the invention the laser source comprises red green and blue emitters.

In one embodiment of the invention the SBG despeckler device further comprises a beam shaping diffuser.

In one embodiment of the invention the SBG despeckler device further comprises a beam collimating lens.

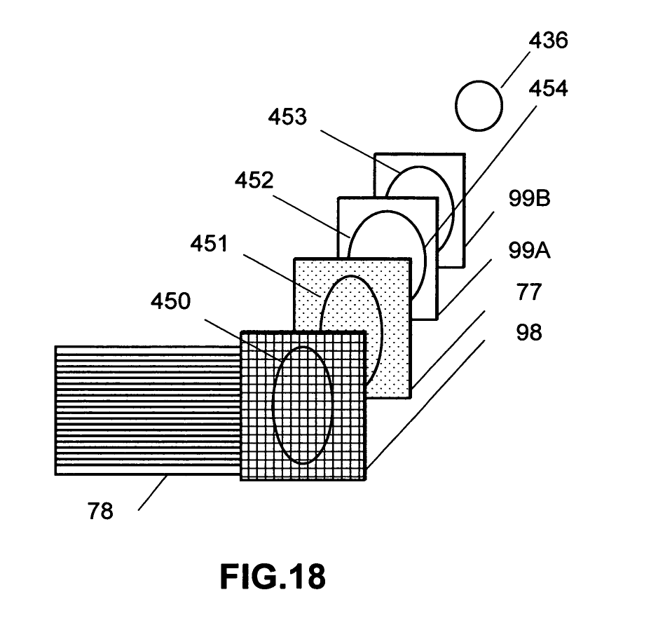

In one embodiment of the invention illustrated in the schematic illustration of FIG. 18 the SBG despeckler device of FIG. 15 generally indicated by 98 further comprises a beam shaping diffuser 77 and two beam collimating lenses 99A,99B. The despeckler device is coupled to drive electronic module (not illustrated) via a data/power communication link indicated by 78. The elliptic beam cross section of light propagating through of the system are indicated by the to symbols 450-453 with the circular output beam being indicated by 454.

The red green and blue laser modules used in the above described embodiments are operated colour sequentially in order to provide colour sequential output light. It will be clear from consideration of the description and drawings that the red green and blue laser modules may emit light continuously if required for specific applications.

In certain embodiments of the invention the SBG array elements may incorporate optical power. The effect of incorporating optical power into the SBG array elements is equivalent to disposing a microlens array in series with the SBG array.

Advantageously, an SBG array is fabricated by first designing and fabricating a CGH with the required optical properties and then recording said CGH into the SBG element. Recording the CGH into the SBG element essentially means forming a hologram of the CGH using conventional holographic recording techniques well known to those skilled in the art of holography.

The invention is not restricted to the projection of information displayed on an electronic display panel. Since the invention can be used to provide despeckled collimated narrow beam width light it is particularly well suited to applications in laser scanner displays.

In any of the embodiments of the invention beam-shaping element disposed along the laser beam paths may be used to shape the intensity profile of the illuminator beam. Laser array tend to have emitting surface aspect ratios of that are incompatible with the aspect ratios of common microdisplay devices. The beam-shaping element may be a light shaping diffuser such as the devices manufactured by POC Inc. (USA) or a Computer Generated Hologram. Other technologies may be used to provide the light shaping function.

Since the above described illuminator embodiments provide mixed S and P-polarized light they are most effectively applied to non polarization display panel technologies such as the Texas Instruments Digital Light Processor (DLP).

The invention is not restricted to any particular laser source configuration. The SBG drive electronics are not illustrated. The apparatus may further comprise relay optics, beam folding mirrors, light integrators, filters, prisms, polarizers and other optical elements commonly used in displays

The present invention does not assume any particular process for fabricating SBG despeckler devices. The fabrication steps may be carried out used standard etching and masking processes. The number of steps may be further increased depending on the requirements of the fabrication plant used. For example, further steps may be required for surface preparation, cleaning, monitoring, mask alignment and other process operations that are well known to those skilled in the art but which do not form part of the present invention

The invention does not rely on any particular method for electrode patterning. The methods described in the co pending PCT Application No. PCT/IB2008/001909 by the present inventors may be used.

It will be clear from the above description of the invention that the SBG despeckler embodiment disclose here may be applied to the reduction of speckle in a wide range of laser displays including front and rear projection displays, wearable displays, scanned laser beam displays and transparent displays for use in viewfinders and HUDs.

In preferred practical embodiments of the invention the SBG layers continued in an SBG despeckler device would be combined in a single planar multilayer device. The multilayer SBG despeckler devices may be constructed by first fabricating the separate SBG and then laminating the SBGs using an optical adhesive. Suitable adhesives are available from a number of sources, and techniques for bonding optical components are well known. The multilayer structures may also comprise additional transparent members, if needed, to control the optical properties of the illuminator.

The advantage of a solid-state approach is the resulting illumination patch can be tailored to provide any required shape. Mechanical devices such as rotating diffusers would normally only provide a circular illumination patch resulting in significant light loss.

The invention is not limited to any particular type of HPDLC or recipe for fabricating HPDLC. The HPDLC material currently used by the inventors typically switches at 170 us and restores at 320 us. The inventors believe that with further optimisation the switching times may be reduced to 140 microseconds.

While the invention has been discussed with reference to single laser die or rectangular arrays of laser die, it should be emphasized that the principles of the invention apply to any configuration of laser die. The invention may be used with any type of laser device. For example the invention may be used with edge-emitting laser diodes, which emit coherent light or infrared energy parallel to the boundaries between the semiconductor layers. More recent technologies such as vertical cavity surface emitting laser (VCSEL) and the Novalux Extended Cavity Surface Emitting Laser (NECSEL) emit coherent energy within a cone perpendicular to the boundaries between the layers. The VCSEL emits a narrow, more nearly circular beam than traditional edge emitters, which makes it easier to extract energy from the device. The NECSEL benefits from an even narrower emission cone angle. Solid-state lasers emit in the infrared. Visible wavelengths are obtained by frequency doubling of the output. Solid-state lasers may be configured in arrays comprising as many as thirty to forty individual dies. The laser die are independently driven and would normally emit light simultaneously

It should be emphasized that the Figures are exemplary and that the dimensions have been exaggerated. For example thicknesses of the SBG layers have been greatly exaggerated.

The SBGs may be based on any crystal material including nematic and chiral types.

In particular embodiments of the invention any of the SBG arrays discussed above may be implemented using super twisted nematic (STN) liquid crystal materials. STN offers the benefits of pattern diversity and adoption of simpler process technology by eliminating the need for the dual ITO patterning process described earlier.

The invention may also be used in other applications such as optical telecommunications

Although the embodiment of FIG. 15 has been described in terms of providing a random distribution of ray directions it should be apparent to those skilled in the art of optical design that the same apparatus could be used to provide any type of ray distribution by suitable choice of prism angles and prism materials. It should also be apparent that any number of output ray directions may be provided including the particular case where just two symmetrically disposed output ray directions are provided. Such an embodiment of the invention may find application in stereoscopic displays where the two ray directions could be used to provide left and right eye perspective light.

It should be understood by those skilled in the art that while the present invention has been described with reference to exemplary embodiments, it is to be understood that the invention is not limited to the disclosed exemplary embodiments. Various modifications, combinations, sub-combinations and alterations may occur depending on design requirements and other factors insofar as they are within the scope of the appended claims or the equivalents thereof.

What is claimed is:

1. A device for reducing laser speckle comprising:
a first transparent optical substrate with an input surface and an output surface;
a second transparent optical substrate with an input surface and an output surface;
a HPDLC subwavelength grating sandwiched between said output surface of said first substrates and said output surface of said second substrate; and
transparent electrodes applied to said output surface of said first substrate and said input surface of said second substrate,
wherein said input surface of said first substrates is optically coupled to a laser source,
wherein said input surface of said second substrate is configured as an array of prismatic elements.

2. The device of claim 1 wherein at least one of said input and output surfaces is planar.

3. The device of claim 1 wherein at least one of said transparent electrodes is patterned in to independently switchable electrode elements such that portions of said HPDLC subwavelength grating may be selectively switched in discrete steps from a fully diffracting to a non diffracting state by an electric field applied across said transparent electrodes.

4. The device of claim 3 wherein said electrode elements have substantially the same cross sectional area as said prismatic elements.

5. The device of claim 4 wherein the centre of said electrode element overlaps the vertex of said prismatic element.

6. The device of claim 4 wherein the centre of said electrode element is offset from the vertex of said prismatic element.

7. The device of claim 1 wherein both said transparent electrodes are continuous, wherein said HPDLC subwavelength grating is selectively switched in discrete steps from a fully diffracting to a non diffracting state by an electric field applied across said transparent electrodes.

8. The device of claim 1 wherein the prisms array is a linear array of elements of triangular cross section.

9. The device of claim 1 wherein the prism array is a two-dimensional array comprising pyramidal elements.

10. The device of claim 1 wherein said prismatic elements are identical.

11. The device of claim 1 the surface angles said prismatic elements have a random distribution.

12. The device of claim 1 wherein said prismatic elements are each characterised by one of at least two different surface geometries.

13. The device of claim 1 wherein said prismatic elements are each characterised by one of at least two different surface geometries, wherein prismatic elements of a each said surface geometry are distributed uniformly across the array.

14. The device of claim 1 wherein said prismatic elements have diffusing surfaces.

15. The device of claim 1 wherein said prism elements each have a height of approximately 1 micron and a length of approximately 30 microns.

16. The device of claim 1 wherein said laser source comprises red green and blue emitters.

17. A device for reducing laser speckle comprising:
red, green and blue laser sources;
a rectangular optical medium;
a first SBG array device having an input surface and an output surface, said output surface being disposed adjacent a first surface of said optical medium;
a second SBG array device having an input surface and an output surface, said input surface being disposed adjacent a second surface of said optical medium, said second surface opposing said first surface;
red, green and blue reflecting mirrors disposed in a stack adjacent a third face of said optical medium;
wherein said first and second SBG array devices are symmetrically disposed along a common optical axis
wherein said input surface of said first SBG array device admits red, green and blue light along a common input direction normal to said first SBG array device,
wherein said output surface of said second SBG array device transmits red green and blue light along a common output direction normal to said second SBG array device,
wherein said first SBG array device diffracts P-polarized red, green and blue light into first second and third directions and transmits incident S-polarized red, green and blue light without substantial deviation,
wherein said P-polarized red, green and blue light undergoes reflection at said red, green and blue reflecting mirrors at said first, second and third angles,
wherein said second SBG array device diffracts said P-polarized red, green and blue light into said output direction,
wherein said second SBG array device transmits said S-polarized red green, and blue light into said output direction without substantial deviation.

18. A device for reducing laser speckle comprising:
red, green and blue laser sources;
a rectangular optical medium;
a first SBG array device having an input surface and an output surface, said output surface being disposed adjacent a first surface of said optical medium;
a second SBG array device having an input surface and an output surface, said input surface being disposed adjacent a second surface of said optical medium, said second surface opposing said first surface;
a stack of red, green and blue reflecting mirrors disposed adjacent a third face of said optical medium; and
a means for vibrating said stack of mirrors along a direction normal to said third surface, wherein said first and second SBG array devices are symmetrically disposed along a common optical axis,
wherein said input surface of said first SBG array device admits red, green and blue light along a common input direction normal to said first SBG array device,
wherein said output surface of said second SBG array device transmits red green and blue light along a common output direction normal to said second SBG array device,
wherein said first SBG array device diffracts P-polarized red, green and blue light into first second and third directions and transmits incident S-polarized red, green and blue light without substantial deviation,
wherein said P-polarized red, green and blue light undergoes reflection at said red, green and blue reflecting mirrors at said first, second and third angles,
wherein said second SBG array device diffracts said P-polarized red, green and blue light into said output direction,
wherein said second SBG array device transmits said S-polarized red green, and blue light into said output direction without substantial deviation.

19. The device of claim 18 wherein said means for vibrating said stack of mirrors is a piezoelectric transducer.

20. The device of claim 18 wherein said means for vibrating said stack of mirrors provides a random vibration characterized by at least one of a random phase or a random amplitude.
